(19) United States
(12) Patent Application Publication
(10) Pub. No.: US 2023/0313088 A1
(43) Pub. Date: Oct. 5, 2023

(54) METHOD FOR PRODUCING LIQUOR HAVING FUNCTIONAL SUGAR AND POLYPHENOL USING NON-ISOTHERMAL SACCHARIFICATION PROCESS, AND APPARATUS FOR PRODUCING SAME

(71) Applicant: INDUSTRY-UNIVERSITY COOPERATION FOUNDATION HANYANG UNIVERSITY ERICA CAMPUS, Ansan-si (KR)

(72) Inventor: Tae Hyun Kim, Yongin-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 18/327,686

(22) Filed: Jun. 1, 2023

Related U.S. Application Data
(63) Continuation of application No. PCT/KR2021/018079, filed on Dec. 2, 2021.

(30) Foreign Application Priority Data
Dec. 2, 2020 (KR) 10-2020-0166778
Dec. 1, 2021 (KR) 10-2021-0169882

(51) Int. Cl. C12C 7/04; C12C 7/165; C12C 11/02; C12C 12/00

(52) U.S. Cl. CPC C12C 7/04; C12C 7/165; C12C 11/02; C12C 12/00; C12C 2200/01

(57) ABSTRACT

Provided is a method for producing a liquor. The method for producing a liquor may comprise the steps of: preparing whole grains comprising husks or stems; pulverizing the whole grains so as to produce a pulverized grain product; producing a first intermediate product by mixing the pulverized grain product, a solvent, and a first enzyme and performing a primary saccharification process at a first temperature; producing a second intermediate product by adding a second enzyme to the first intermediate product and performing a secondary saccharification process at a high second temperature different from the first temperature; and adding yeast to the second intermediate product and fermenting.

### CROSS REFERENCE TO RELATED APPLICATIONS

This is a continuation of PCT/KR2021/018079 (filed 2 Dec. 2021), which claims the benefit of Republic of Korea Patent Application KR 10-2020-0166778 (filed 2 Dec. 2020) and Republic of Korea Patent Application KR 10-2021-0169882 (filed 1 Dec. 2021). The entire disclosure of each of these priority applications is hereby incorporated by reference herein.

### TECHNICAL FIELD

The present application relates to a method for producing a liquor and an apparatus for producing the same, and more specifically, to a method for producing a liquor and an apparatus for producing the same having a functional sugar and polyphenol of whole grains using a non-isothermal rapid saccharification process and a fermentation process.

### BACKGROUND ART

Most of the liquid produced at home is manufactured by large companies, and thus “Light Lager” has accounted for more than 80% of the Korean liquor market.

In early 2020, however, the Liquor Tax Act was revised to volume-based tax, and the improvement of domestic liquor regulations, which calls for “allowing the production of liquor by consigned manufacturing method,” “sale by order through mobile devices,” “the possibility of selling nitrogen gas filled liquor cans,” and the like, was announced with a growing expectation that an era of diversity of Korean liquors will come.

Along with this change, various liquor manufacturing methods are being developed according to the consumer's preference.

For example, Korean Registered Patent No. 10-1154377 discloses a method for producing a liquor containing wood-cultivated ginseng, which includes: a malt pulverizing process of pulverizing malt stored in a storage using a pulverizer; a dipping process of mixing the pulverized malt with 30-75° C. water in a dipping tank to extract wort; a filtering process of filtering the extracted wort in a filtering tank and extracting fermentable ingredients remaining in a dipping residue; a boiling process of adding the filtered wort in a boiling tank while heating at a high temperature of 100° C. or higher; a whirlpool process of supplying the boiled wort to whirlpool to remove the malt and draft beer residue; a cooling and oxygen supply process of cooling the wort, which has undergone the whirlpool process, to 12-18° C. at which yeast is fermentable, in a wort cooler and supplying oxygen; a fermentation process of adding the cooled wort into a fermentation tank and injecting the yeast so as to generate immature liquor after two to seven days; a maturation process of adding the fermented immature liquor into a maturation tank and maturing the same for 7 to 21 days so as to contain alcohol per se; and a filtering process of adding the mature liquor into a liquor filter and filtering the same to produce a transparent liquor, wherein the method includes a washing process of washing the leaves, stems, and roots of the wood-cultivated ginseng with water and a slicing process of slicing the leaves, stems, and roots of the washed wood-cultivated ginseng into a size of 3-5 cm before the boiling process; wherein the sliced leaves, stems, and roots of the wood-cultivated ginseng are added with the filtered wort during the boiling process; and wherein the sliced leaves, stems, and roots of the wood-cultivated ginseng are removed together with other residues during the whirlpool process.

### DETAILED DESCRIPTION OF THE INVENTION

### Technical Problem

One technical object of the present application is to provide a method for producing a liquor with excellent taste and flavor and an apparatus for producing the same.

Another technical object of the present application is to provide a method for producing a liquor, of which taste, flavor and color may be controlled according to a consumer's preference, and an apparatus for producing the same.

Still another technical object of the present application is to provide a method for producing a liquor using a non-isothermal saccharification process capable of saccharifying and fermenting a malt peel and a starch portion together, and an apparatus for producing the same.

Still another technical object of the present application is to provide a method for producing a liquor having a functional sugar and polyphenol contained in a malt peel, and an apparatus for producing the same.

The technical objects of the present invention are not limited to the above.

### Technical Solution

To solve the above technical objects, the present application may provide a method for producing a liquor.

According to one embodiment, the method for producing a liquor may include: preparing whole grains containing husks or stems; pulverizing the whole grains so as to produce a pulverized grain product; producing a first intermediate product by mixing the pulverized grain product, a solvent, and a first enzyme and performing a primary saccharification process at a first temperature; producing a second intermediate product by adding a second enzyme to the first intermediate product and performing a secondary saccharification process at a second temperature different from the first temperature; and adding yeast to the second intermediate product and fermenting.

According to one embodiment, the cellulose of the pulverized husks or pulverized stems contained in the pulverized grain product may be saccharified in the primary saccharification process so as to generate a functional sugar.

According to one embodiment, the functional sugar may include at least one of xylose, mannose, arabinose, galactose, rhamnose, an oligosaccharide form, or β-glucan.

According to one embodiment, lignin contained in the pulverized husks or pulverized stems included in the pulverized grain product may be dissolved in the primary saccharification process so as to generate polyphenol.

According to one embodiment, starch contained in the pulverized grain product may be saccharified in the secondary saccharification process.

According to one embodiment, the first enzyme may include cellulase and the second enzyme may include amylase.

According to one embodiment, the method for producing a liquor may further include heat-treating the pulverized grain product while providing an extraction solution so as to remove lignin contained in the pulverized grain product, and gelating the pulverized grain before the primary saccharification process, in which the solvent and the first enzyme may be mixed with the gelated pulverized grain product so as to perform the primary saccharification process.

According to one embodiment, the whole grains may be pulverized by a colloid milling method.

To solve the above technical objects, the present application may provide an apparatus for producing a liquor.

According to one embodiment, the apparatus for producing a liquor may include a pulverizing unit configured to pulverize whole grains to produce a pulverized grain product, a saccharification tank configured to perform a primary saccharification process of saccharifying the pulverized grain product at a first temperature so as to produce a first intermediate product and a secondary saccharification process of saccharifying the first intermediate product at a second temperature different from the first temperature so as to produce a second intermediate product, and a fermentation tank configured to ferment the saccharified pulverized grain product.

According to one embodiment, in the primary saccharification process at the first temperature, cellulose contained in the pulverized grain product may be saccharified to generate a functional sugar, and lignin of the pulverized grain product may be dissolved to generate polyphenol, and starch contained in the pulverized grain product may be saccharified in the secondary saccharification process at the second temperature.

According to one embodiment, the apparatus for producing a liquor may further include a filter unit configured to remove lignin from the pulverized grain product by heat-treating the pulverized grain product while providing a pre-treatment solvent to the pulverized grain product.

According to one embodiment, the primary saccharification process and the secondary saccharification process may be sequentially performed in the same reaction tank.

According to one embodiment, the apparatus for producing a liquor may include a pulverizing unit configured to pulverize whole grains to produce a pulverized grain product, and a reaction tank configured to saccharify and ferment the pulverized grain product, in which the reaction tank may include a saccharification region and a fermentation region which are divided by a membrane, in which in the saccharification region, the pulverized grain product may be saccharified to produce the first intermediate product and the first intermediate product may be saccharified to produce a second intermediate product, and a pore of the membrane may be smaller than the yeast and may be larger than sugar generated by saccharifying the pulverized grain product in the saccharification region, and thus the membrane may selectively permeate the sugar.

According to one embodiment, the saccharification process of the pulverized grain product in the saccharification region and the fermentation of the second intermediate product in the fermentation region may be simultaneously performed in the one reaction tank.

### Advantageous Effects

According to the method for producing a liquor in accordance with an embodiment of the present application, the liquor can be produced by pulverizing whole grains containing husks or stems to produce a pulverized grain product, producing a first intermediate product by mixing the pulverized grain product and a first enzyme and performing a primary saccharification process at a first temperature, producing a second intermediate product by adding a second enzyme to the first intermediate product and performing a secondary saccharification process at a second temperature different from the first temperature, and adding yeast to the second intermediate product and fermenting.

The cellulose contained in the pulverized grain product may be decomposed in the first saccharification process to generate a functional sugar, and the lignin contained in the pulverized grain product may be dissolved to generate polyphenol. Accordingly, the flavor and scent of the liquor may be enhanced.

In addition, after the first saccharification process using the first enzyme is performed at the first temperature which is relatively low, the second saccharification process using the second enzyme may be performed at the second temperature which is relatively high, and thus deactivation of the first enzyme at a high temperature may be prevented, and the first saccharification process may be easily performed.

### DESCRIPTION OF DRAWINGS

FIG. 1 is a flowchart for explaining a method for producing a liquor according to an embodiment of the present application.

FIG. 2 is a view for explaining a method for preparing a pulverized grain product in a method for producing a liquor according to an embodiment of the present invention.

FIG. 3 is a view for explaining a saccharification tank included in an apparatus for producing a liquor according to an embodiment of the present application.

FIG. 4 is a view for explaining a fermentation tank included in an apparatus for producing a liquor according to an embodiment of the present application.

FIG. 5 is a view for explaining a method for producing a liquor according to a first modified example of the present application.

FIG. 6 is a view for explaining a filter unit included in an apparatus for producing a liquor according to a first modified example of the present application.

FIG. 7 is a view for explaining a method for producing a liquor according to a second modified example of the present application.

FIG. 8 is a view for explaining a method for producing a liquor according to a third modified example of the present application.

FIG. 9 is a view for explaining a method for producing a liquor according to a fourth modified example of the present application.

### DETAILED DESCRIPTION OF THE EMBODIMENTS

Hereinafter, preferred embodiments of the present invention will be described in detail with reference to the accompanying drawings. However, the technical idea of the present invention is not limited to the embodiments described herein and may be embodied in other forms. Rather, the embodiments introduced herein are provided to sufficiently deliver the spirit of the present invention to those skilled in the art so that the disclosed contents may become thorough and complete.

Further, in the drawings, a size of each element is exaggerated for efficient description of the technical contents.

In addition, in the various embodiments of the present specification, the terms such as first, second, and third are used to describe various elements, but the elements are not limited to the terms. These terms are used only to distinguish one element from another element. Accordingly, an element mentioned as a first element in one embodiment may be mentioned as a second element in another embodiment. Each of the embodiments described and illustrated herein also include their complementary embodiments. Further, the term “and/or” in the present specification is used to include at least one of the elements enumerated in the specification.

In the specification, the terms of a singular form may include plural forms unless otherwise specified. Further, the terms “including” and “having” are used to designate that the features, the numbers, the steps, the elements, or combinations thereof described in the specification are present, and are not to be understood as excluding the possibility that one or more other features, numbers, steps, elements, or combinations thereof may be present or added.

Further, in the following description of the present invention, a detailed description of known functions and configurations incorporated herein will be omitted when it may make the subject matter of the present invention unnecessarily unclear.

Unlike an embodiment of the present application described above, according to a first modified example, the “liquor” of the specification of the present application may include a fermented liquor such as wine and the like of lignin included in the pulverized grain product 20, may be used as a raw material of a distilled liquor, and may be interpreted to include various alcoholic beverages.

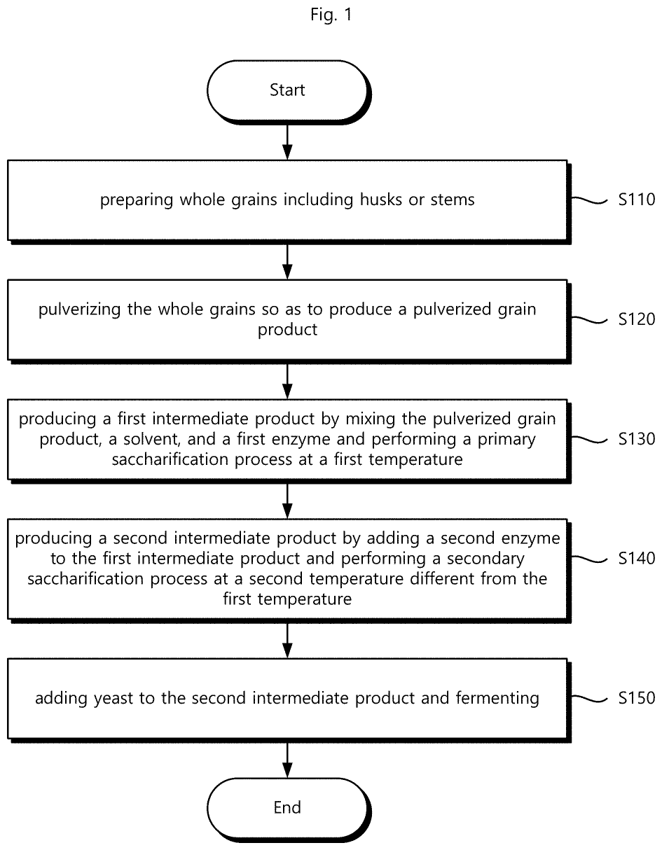

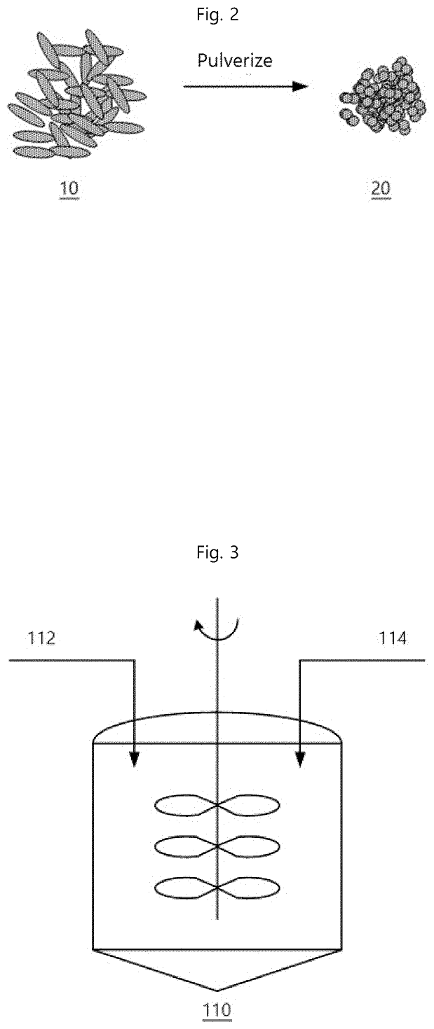

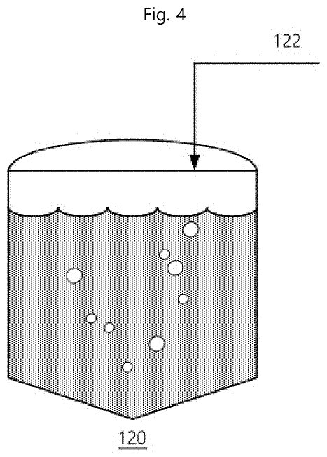

FIG. 1 is a flowchart for explaining a method for producing a liquor according to an embodiment of the present application, FIG. 2 is a view for explaining a method for preparing a pulverized grain product in a method for producing a liquor according to an embodiment of the present invention, FIG. 3 is a view for explaining a saccharification tank included in an apparatus for producing a liquor according to an embodiment of the present application, and FIG. 4 is a view for explaining a fermentation tank included in an apparatus for producing a liquor according to an embodiment of the present application.

Referring to FIGS. 1 to 4, whole grains 10 containing husks or stems may be prepared (S110).

For example, the whole grains 10 may be barley whole grains including barley husks and/or barley stems. Alternatively, for another example, the whole grains may be rice whole grains including rice bran and/or rice straw.

According to one embodiment, the preparing of the whole grains 10 may include supplying moisture to the whole grains 10 to germinate the same, and drying the germinated whole grains 10 with hot air.

The whole grains 10 may be pulverized to produce a pulverized grain product 20 (S120).

According to one embodiment, the whole grains 10 may be finely pulverized using a colloid mill, and the pulverized grain product 20 may have a size of micrometer or nanometer level. Accordingly, as will be described later, the cellulose contained in the pulverized grain product 20 may be easily saccharified.

A first intermediate product may be produced by mixing the pulverized grain product 20, a solvent, and a first enzyme 112 and performing a primary saccharification process at a first temperature (S130).

As described above, the whole grains 10 may include husks and/or stems. Accordingly, the pulverized grain product 20 obtained by pulverizing the whole grains 10 may include pulverized husks and pulverized stems.

The pulverized husks and the pulverized stems may contain a large amount of cellulose (hemicellulose). In the primary saccharification process, the cellulose of the pulverized husks and the pulverized stems included in the pulverized grain product 20 may be saccharified by hydrolysis using the first enzyme 112 so as to generated a functional sugar. According to one embodiment, the first temperature may be 40° C.-50° C. and the first enzyme 112 may include cellulase (specifically, α- and/or β-cellulase and/or hemicellulase) capable of hydrolyzing and saccharifying cellulose. For example, the primary saccharification process may be also performed for 6-72 hours.

In addition, as described above, the whole grains 10 may be pulverized at a micrometer or nanometer level using a colloid mill, and thus the cellulose may be easily saccharified.

The functional sugar generated by decomposing the cellulose contained in the pulverized husks and the pulverized stems may include at least one of monosaccharides xylose, mannose, arabinose, galactose, and rhamnose, oligosaccharide thereof, or β-glucan, and the flavor and scent of liquor may be enhanced by the functional sugar.

In addition, in the primary saccharification process, lignin contained in the pulverized husks and the pulverized stems may be dissolved to generated polyphenol. Accordingly, the flavor and scent of the liquor may be enhanced.

A second enzyme 114 may be added to the first intermediate product generated by the primary saccharification process, and a secondary saccharification process may be performed at a second temperature different from the first temperature, and thus a second intermediate product (sweet wort) may be produced (S140).

According to one embodiment, the second temperature may be higher than the first temperature. For example, the second temperature may be 60° C.-90° C. higher than the first temperature, and the second enzyme 112 may include amylase (specifically, α-amylase and β-amylase) capable of decomposing and saccharifying the starch contained in the first intermediate product.

The primary saccharification process and the secondary saccharification process may be continuously performed. In other words, after the primary saccharification process is finished, the secondary saccharification process may be immediately performed by increasing a temperature from the first temperature to the second temperature.

In addition, the primary saccharification process and the secondary saccharification process may be in-situ performed in the same saccharification tank. Accordingly, a time for performing the primary saccharification process and the secondary saccharification process may be shortened, process convenience may be enhanced, and process costs may be reduced.

In addition, after the primary saccharification process using the first enzyme 112 is performed at the first temperature which is relatively low, the secondary saccharification process using the second enzyme 114 may be performed at the second temperature which is relatively high. In other words, the primary saccharification process may be first performed at the first temperature, which is relatively low, by using the first enzyme 112 that is deformed at a high temperature to decrease activity, and thus the primary saccharification process of saccharifying the cellulose may be easily performed.

Unlike the above-described embodiment of the present application, when the secondary saccharification process using the second enzyme 114 for saccharifying starch is performed, the primary saccharification process using the first enzyme 112 may not be easily performed due to the secondary saccharification process having a relatively high temperature, and thus the functional sugar may not be generated or lignin may not be dissolved not to generate polyphenol.

As described above, however, according to an embodiment of the present application, the primary saccharification process using the first enzyme 112 sensitive to a high temperature may be performed at the first temperature, which is relatively low, earlier than the secondary saccharification process, and thus the first enzyme 112 may maintain high activity, and as a result, the functional sugar may be easily generated from the cellulose in the primary saccharification process and polyphenol may be easily generated from lignin.

Yeast 122 may be added to the second intermediate product and fermented (S140).

According to one embodiment, the second intermediate product may be fermented by the yeast 122 before being fermented, after being filtered, heat-treated, and cooled.

Specifically, as shown in FIG. 4, the second intermediate product may be provided in a fermentation tank 120, and a fermentation process may be performed by adding the yeast 122. After that, the liquor may be produced by removing impurities and aging.

As described above, the second intermediate product may include the functional sugar and the polyphenol. Accordingly, the second intermediate product may be fermented by the yeast 122 together with the functional sugar and the polyphenol, and accordingly, the flavor and scent of the liquor may be improved.

According to one embodiment, the liquor may be a beer, the first intermediate product may be a mash, and the second intermediate product may be a wort.

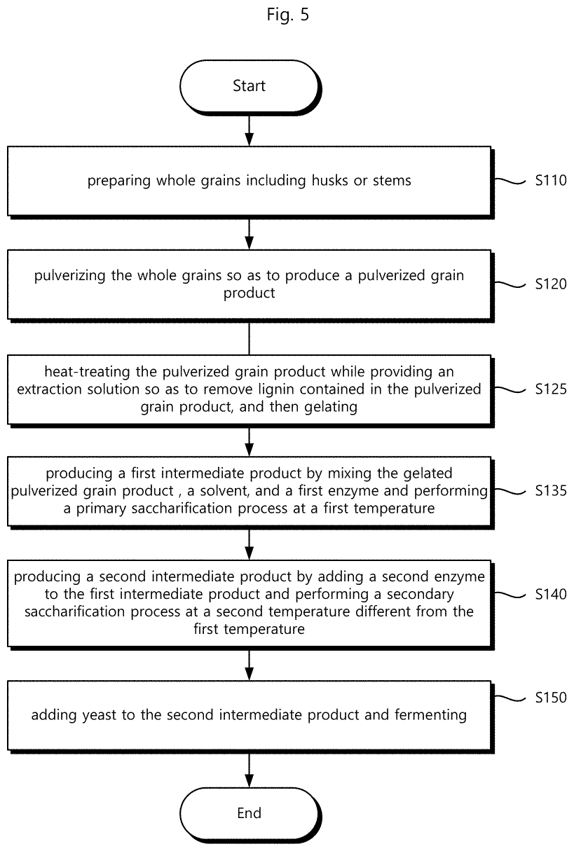

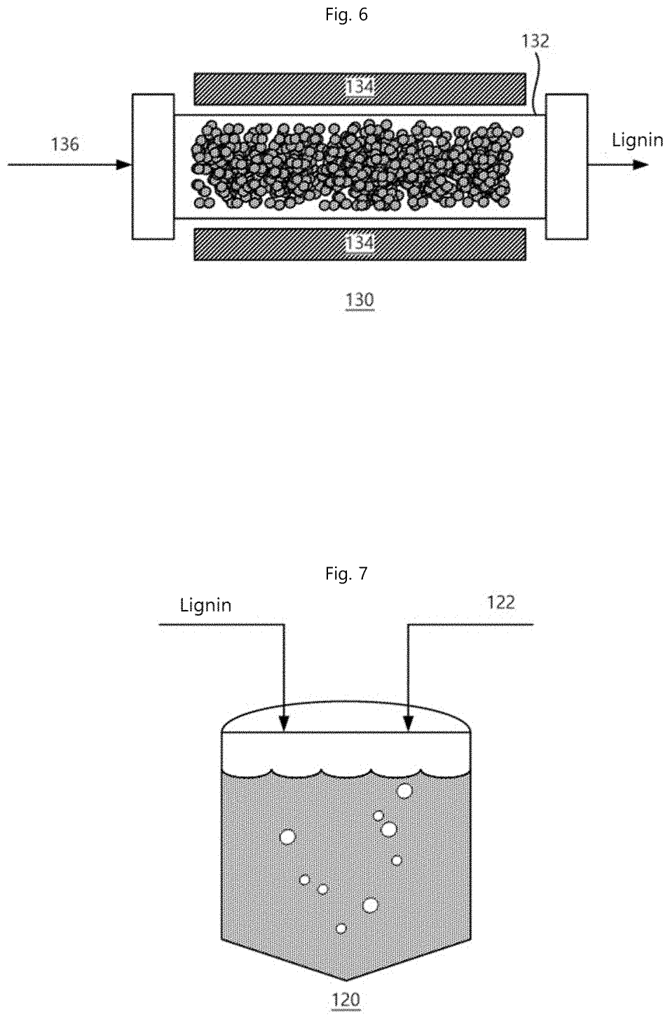

Unlike the above-described embodiment of the present application, according to the first modified example, a portion of lignin contained in the pulverized grain product may be removed. Hereinafter, a method and an apparatus for producing a liquor according to the first modified example of the present application will be described with reference to FIGS. 5 and 6.

FIG. 5 is a view for explaining a method for producing a liquor according to a first modified example of the present application, and FIG. 6 is a view for explaining a filter unit included in an apparatus for producing a liquor according to a first modified example of the present application.

Referring to FIGS. 5 and 6, the pulverized grain product 20 may be prepared as described with reference to FIGS. 1 to 4.

According to the first modified example of the present application, at least a portion of lignin contained in the pulverized grain product 20 may be removed before performing the primary saccharification process by using the pulverized grain product 20.

Specifically, as shown in FIG. 6, the pulverized grain product 20 may be provided in a container 132 of the filter unit 130 and an extraction solution 136 may be provided from one side of the container 132 and eluted to the other side thereof while heat-treating the pulverized grain product 20 by using a heater 134. In this process, while high temperature (for example, 50-220° C.) and pressure are applied to the pulverized grain product 20, the lignin of the pulverized grain product 20 may be dissolved by the extraction solution 136 and discharged to the outside and the pulverized grain product 20 may be gelated together. The extraction solution 136 may include water and ethanol, and the extraction solution 136 may be provided to the container 132 for 5 to 60 minutes.

According to one embodiment, an amount of lignin removed from the pulverized grain product 20, that is, an amount of lignin remaining in the pulverized grain product 20, may be adjusted by controlling a time for providing the extraction solution 136 and a temperature heat-treated by the heater 134. Specifically, as the time for providing the extraction solution 136 is increased and the heat treatment temperature by the heater 134 is increased, the amount of the lignin removed from the pulverized grain product 20 may be increased.

The primary saccharification process, the secondary saccharification process, and the fermentation process described with reference to FIGS. 1 to 4 may be sequentially performed by using the pulverized grain product 20 in a gel state, from which at least a portion of lignin is removed, thereby producing a liquor.

According to the first modified example of the present application, the amount of the lignin remaining in the pulverized grain product 20 may be adjusted by a simple method of controlling the heat treatment temperature and the time for providing the extraction solution 136. The flavor and scent of the liquor may be controlled according to the amount of the lignin remaining in the pulverized grain product 20, and thus, the alcohol having differentiated flavor and scent may be easily produced according to various consumer preferences.

Unlike the above-described embodiment of the present application, according to a second modified example, lignin may be further added during a fermentation process or after the fermentation. Hereinafter, a method for producing a liquor according to the first modified example of the present application will be described with reference to FIG. 7.

FIG. 7 is a view for explaining a method for producing a liquor according to a second modified example of the present application.

Referring to FIG. 7, the whole grains 10 may be prepared, the whole grains 10 may be germinated by supplying moisture thereto, the germinated whole grains 10 may be heat-treated, and then the pulverized grain product may be produced from the whole grains 10, as described with reference to FIGS. 1 to 4.

With regard to the pulverized grain product 20, the primary saccharification process and the secondary saccharification process may be performed to produce the second intermediate product, as described with reference to FIGS. 1 to 4. The second enzyme 114 naturally present in the pulverized grain product 20 may be inactivated during the heat treatment of the germinated whole grains 10, and accordingly, the second enzyme 114 may be further added in the secondary saccharification process.

In addition, lignin may be extracted from husks and stems. Specifically, lignin may be extracted from husks and stems by a method of providing an extraction solution containing ethanol in the husks and stems.

Meanwhile, after lignin is extracted, the remaining husks and stems may be used as feed.

According to one embodiment, after the second intermediate product produced by the above-described method is provided into the fermentation tank 120, the yeast 122, and the lignin extracted from the husks and stems may be added, and a fermentation process may be performed.

Alternatively, according to another embodiment, the second intermediate product and the yeast 122 produced by the above-described method may be supplied into the fermentation tank 120 and fermented to produce a liquor, and then, the lignin extracted from the husks and stems may be added.

According to a second modified example of the present application, lignin extracted through a separate process may be added during or after the fermentation process. Accordingly, an amount of lignin added may be also precisely controlled, and a large amount of the second intermediate product or the liquor may be produced, after which a liquor having various flavors and scents may be easily produced by adding lignin at various concentrations.

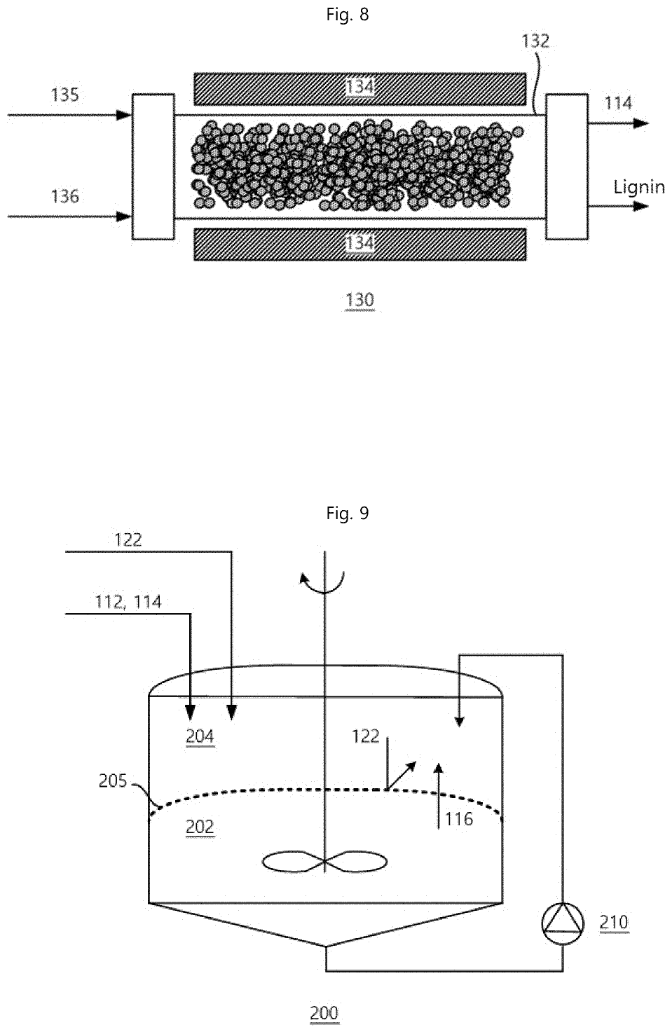

Unlike the above-described embodiment of the present application, according to a third modified example, the second enzyme may be extracted and the second saccharification process may be performed by using the extracted second enzyme. Hereinafter, a method for producing a liquor according to the third modified example of the present application will be described with reference to FIG. 8.

FIG. 8 is a view for explaining a method for producing a liquor according to a third modified example of the present application.

Referring to FIG. 8, the whole grains 10 may be prepared, and the whole grains 10 may be germinated by supplying moisture thereto, as described with reference to FIGS. 1 to 4. The germinated whole grains 10 may be pulverized as described with reference to FIGS. 1 to 4 so as to produce the pulverized grain product 20.

After that, the pulverized grain product 20 may be placed in the container 132 of the filter unit 130, hot water 135 (for example, about 60° C.) may be provided to extract the second enzyme 114 from the pulverized grain product 20, and then the extraction solution 136 may be provided and heat-treated at a high temperature (for example, 150-190° C.) so as to extract lignin from the pulverized grain product 20 and simultaneously gelate the pulverized grain product 20.

After that, as described with reference to FIGS. 1 to 4, the primary saccharification process may be performed on the gelated pulverized grain product 20, and then the secondary saccharification process may be performed by using the extracted second enzyme 114.

A gelation reaction, that is, a hydration reaction, may be easily performed through a high-temperature pre-treatment on the pulverized grain product 20, and a time required for the secondary saccharification process may be saved through hydrolysis of starch. In addition, the efficiency of the second enzyme 114 may be maximized to reduce an amount of the second enzyme 114 used.

Unlike the above-described embodiment of the present application, according to a fourth modified example, the saccharification process and the fermentation process may be performed in one reaction tank. Hereinafter, a method for producing a liquor according to the fourth modified example of the present application will be described with reference to FIG. 9.

FIG. 9 is a view for explaining a method for producing a liquor according to a fourth modified example of the present application.

Referring to FIG. 9, the pulverized grain product 20 described with reference to FIGS. 1 to 4 may be prepared, and the saccharification process and the fermentation process for the pulverized grain product 20 may be simultaneously performed in one reactor 200.

Specifically, the reaction tank 200 may include a saccharification region 202 and a fermentation region 204, which are divided by a membrane 205 or a micro/nanopore perforated plate. The membrane 205 may have a plurality of pores, and the pore of the membrane 205 may be smaller than a size of the yeast 122 and larger than a size of a sugar 116. Accordingly, the yeast 122 may not permeate the membrane 205, and the sugar 116 may permeate the membrane 205. In other words, the membrane 205 may selectively permeate the sugar 116.

The pulverized grain product 20, a solvent, and the first enzyme 112 may be provided into the reaction tank 200, and the primary saccharification process described with reference to FIGS. 1 to 4 may be performed in the saccharification region 202 of the reaction tank 200.

After that, the second enzyme 114 may be provided into the reaction tank 200, and the secondary saccharification process described with reference to FIGS. 1 to 4 may be performed therein.

The sugar 116 generated by the secondary saccharification process may permeate the membrane 205 and move to the fermentation region 204, and a reactant in the reaction tank 200 may be circulated and supplied through a pump 210 together.

The sugar 106 moved to the fermentation region 204 may be fermented by the yeast 122 supplied from the fermentation region 204.

Accordingly, the saccharification process and the fermentation process may be continuously or simultaneously performed in one reaction tank 200.

Although the present invention has been described in detail with reference to exemplary embodiments, the scope of the present invention is not limited to a specific embodiment and should be interpreted by the attached claims. In addition, those skilled in the art should understand that many modifications and variations are possible without departing from the scope of the present invention.

### INDUSTRIAL APPLICABILITY

The method for producing a liquor and an apparatus for producing the same having a functional sugar and polyphenol using a non-isothermal saccharification process according to an embodiment of the present application can be utilized as a process for producing various liquors and alcoholic beverages and an apparatus for producing the same.

What is claimed is:

1. A method for producing a liquor, the method comprising:
preparing whole grains including husks or stems;
pulverizing the whole grains so as to produce a pulverized grain product;
producing a first intermediate product by mixing the pulverized grain product, a solvent, and a first enzyme and performing a primary saccharification process at a first temperature;
producing a second intermediate product by adding a second enzyme to the first intermediate product and performing a secondary saccharification process at a second temperature different from the first temperature; and
adding yeast to the second intermediate product and fermenting.

2. The method of claim 1, wherein cellulose of the pulverized husks or pulverized stems contained in the pulverized grain product is saccharified in the primary saccharification process so as to generate a functional sugar.

3. The method of claim 2, wherein the functional sugar comprises at least one of xylose, mannose, arabinose, galactose, rhamnose, an oligosaccharide form, or β-glucan.

4. The method of claim 1, wherein lignin contained in the pulverized husks or pulverized stems included in the pulverized grain product is dissolved in the primary saccharification process so as to generate polyphenol.

5. The method of claim 1, wherein starch contained in the pulverized grain product is saccharified in the secondary saccharification process.

6. The method of claim 1, wherein the first enzyme comprises cellulase, and the second enzyme comprises amylase.

7. The method of claim 1, further comprising:
before the primary saccharification process,
heat-treating the pulverized grain product while providing an extraction solution so as to remove lignin contained in the pulverized grain product, and then gelating, wherein
the solvent and the first enzyme are mixed with the gelated pulverized grain product so as to perform the primary saccharification process.

8. The method of claim 1, wherein the whole grains are pulverized by a colloid milling method.

9. An apparatus for producing a liquor, which comprises:
a pulverizing unit configured to pulverize whole grains so as to produce a pulverized grain product;
a saccharification tank configured to perform a primary saccharification process of saccharifying the pulverized grain product at a first temperature so as to produce a first intermediate product and a secondary saccharification process of saccharifying the first intermediate product at a second temperature different from the first temperature so as to produce a second intermediate product; and
a fermentation tank configured to ferment the saccharified pulverized grain product.

10. The apparatus of claim 9, wherein in the primary saccharification process at the first temperature, cellulose comprised in the pulverized grain product is saccharified to produce a functional sugar, and lignin of the pulverized grain product is dissolved to generate polyphenol, and
starch comprised in the pulverized grain product is saccharified in the secondary saccharification process at the second temperature.

11. The apparatus of claim 9, further comprising:
a filter unit configured to remove lignin from the pulverized grain product by heat-treating the pulverized grain product while providing a pre-treatment solvent to the pulverized grain product.

12. The apparatus of claim 9, wherein the primary saccharification process and the secondary saccharification process are sequentially performed in a same reaction tank.

13. An apparatus for producing a liquor, which comprises:
a pulverizing unit configured to pulverize whole grains to produce a pulverized grain product; and
a reaction tank configured to saccharify and ferment the pulverized grain product, wherein
the reaction tank comprises a saccharification region and a fermentation region which are divided by a membrane,
wherein in the saccharification region, the pulverized grain product is saccharified to produce the first intermediate product and the first intermediate product is saccharified to produce a second intermediate product, and
in the fermentation region, yeast is added to the second intermediate product, and wherein
a pore of the membrane is smaller than the yeast and is larger than sugar generated by saccharifying the pulverized grain product in the saccharification region, and thus the membrane selectively permeates the sugar.

14. The apparatus of claim 13, further comprising:
the saccharification process of the pulverized grain product in the saccharification region and the fermentation of the second intermediate product in the fermentation region are simultaneously performed in the one reaction tank.
